(19) United States
(12) Patent Application Publication
(10) Pub. No.: US 2021/0276084 A1
(43) Pub. Date: Sep. 9, 2021

(54) NANOPARTICLE SELF-ASSEMBLING METHOD FOR FORMING CORE-SHELL NANOHYBRIDS

(71) Applicant: FLORIDA ATLANTIC UNIVERSITY BOARD OF TRUSTEES, Boca Raton, FL (US)

(72) Inventors: Peng YI, Boca Raton, FL (US); Kazi Albab HUSSAIN, Lincoln, NE (US)

(21) Appl. No.: 17/163,071

(22) Filed: Jan. 29, 2021

Related U.S. Application Data
(60) Provisional application No. 62/986,585, filed on Mar. 6, 2020.

(51) Int. Cl. B22F 1/00; C08F 212/08

(52) U.S. Cl. CPC B22F 1/0062; B82Y 30/00; C08F 212/08; B22F 1/0022

(57) ABSTRACT

A method of synthesizing core-shell nanohybrids is described herein. The method includes providing first nanoparticles and second nanoparticles in a liquid medium at a pH at which the first nanoparticles are neutral and the second nanoparticles are negatively charged, allowing the first nanoparticles to homoaggregate and form a core of at least one of the first nanoparticles, and allowing the second nanoparticles to heteroaggregate with the homoaggregated first nanoparticles to form a shell on the core so as to provide the core-shell nanohybrids. A nanohybrid is additionally described herein, which includes a core including at least one neutral nanoparticle within a shell containing charged nanoparticles, wherein the shell further includes nanogaps configured to allow access of substrates to the core.

### BACKGROUND OF THE INVENTION

### 1. Field of Invention

This invention relates to methods of forming core-shell nanohybrids by nanoparticle self-assembly.

### 2. Description of Related Art

Nanoparticles (NPs) are widely used in photocatalysis, water and wastewater treatment to degrade or remove organic and inorganic pollutants, nanomedicine, fuel cells, soil remediation by removing pollutants, groundwater remediation, drug delivery, etc.

However, many nanoparticles have the tendency to form large agglomerates in aqueous media and polymer matrices, which results in decreased mobility, surface area, and catalytic properties. Formation of core-shell nanohybrids effectively prevents the aggregation of the nanoparticles. In addition, core-shell nanohybrids may provide improved physical and chemical properties due to a synergistic effect of the core and shell nanoparticles (21, 22).

Core-shell nanohybrids have shown great promise in a wide variety of applications, including but not limited to catalysis (1, 2), photocatalysis (3, 4), sensing (5-7), smart drug delivery (8, 9), multimodal imaging (10-13), photothermal therapy (12, 13), energy storage (14-16), photovoltaic device (17, 18), and synthetic bone grafts (19, 20).

Core-shell multiwalled carbon nanotube/amorphous carbon nanohybrids have been designed using surfactant and a hydrothermal reaction (9) to be used as filler material to improve dielectric properties of composite materials (10).

Ag—Fe₃O₄ core-shell nanohybrids have been synthesized, which have improved surface plasmon resonance and thus the potential to be used as a surface-enhanced Raman scattering substrate and highly sensitive detection platform (11). They were made using the one-step synthesis process involving the reaction of silver acetate and iron acetylacetonate, followed by the purification of ethanol-induced precipitation.

Near infrared responsive core-shell gold nanorod/N-isopropylacrylamide nanohybrids have been synthesized for smart drug delivery, localized therapy, and cancer treatment by “graft-from” method, which involves the surface-initiated atom transfer radical polymerization (12, 13).

Magnetic NPs-carbon based core-shell nanohybrids have been synthesized for improved microwave absorbing capacity using the method which involves catalytic decomposition of acetylene with the control of pyrolysis temperature and further cooling to room temperature (14).

Two core-shell nanohybrids i.e. Ag—SiO₂—Ag_{Seed} core-shell-shell nanohybrids (Ag@SiO₂@Ag_{seed}) and Ag—SiO₂-AgNPs core-shell-shell nanohybrids (Ag@SiO₂@AgNPs) have been prepared for combined simultaneous photothermal therapy and bioimaging in medical applications using the Stober method which requires heating of 120° C., vigorous stirring (15) and high rpm centrifugation (16, 17).

Fe₂O₃—SnO₂ core-shell nanohybrids that are used for sensing ethanol vapor have been prepared from the precursor solution obtained from a mixture of iron (III) nitrate nonahydrate and ethanol using the flame-assisted spray pyrolysis method (18).

Fe₃O₄-tannic acid (TA) core-shell structure coated with AgNPs (Fe₃O₄@TA@AgNPs) has been fabricated for improved electrochemical detection and catalytic reduction of ecotoxic 4-nitrophenol using hydrothermal method followed by a precipitation-deposition method (19).

Silica-gelatin hydrophobic nanohybrids have been fabricated using sol-gel method to gain improved biocompatibility, contact angle, and optical transmittance so that they can be used for optical applications and making coatings to improve biocompatibility and hydrophobicity of leather (20).

The increased demand and use of core-shell nanohybrids have prompted research into methods of synthesizing them. Several methods have been commonly used, including: hydrothermal methods (6, 23, 24), sol-gel methods (25-27), refluxing processes (27-29), flame spray pyrolysis (7, 30, 31), and the Stober method (29, 32, 33). All of them are energy intensive processes. Hydrothermal method, the most popular method used by material scientists, requires the heating of the precursor solution in an autoclave at high temperatures (6, 23, 24) (e.g., heating at 180° C. for 5 hours for Cu-Carbon nanohybrid fabrication (6)), and in some cases, the carbonation or calcination process at an even higher temperature (e.g., carbonization of CoO at 450° C. for the fabrication of CoO—MnO₂ core-shell nanohybrids (23)). The sol-gel method, another common method in nanomaterial synthesis, typically involves annealing at elevated temperature to form a gel phase (25-27) (e.g., annealing at 60° C. for 1 h for Au—SnO₂ nanohybrid synthesis (26)). In addition, surfactants may be added to facilitate the growth of the shell on the core material (e.g., trisodium citrate solution at the boiling point was added in the precursor solution for the fabrication of Au—SnO₂ nanohybrid (26)). The formation of core-shell nanohybrids in refluxing process requires long-period heating of the precursor solution (27-29) (e.g., the heating of precursor solution at 100° C. for 24 hours for the synthesis of CdS nanosphere-TiO₂ core-shell nanohybrids (28)). Flame spray pyrolysis, as the name suggests, requires reaction of precursors in a flame chamber at high temperatures (7, 30, 31) (e.g., the fabrication of Fe₂O₃—SnO₂ core-shell in the flame (7)). The Stober method, widely used for fabricating silica-based core-shell nanohybrids, does not necessarily involve heating. However, it requires hours of vigorous stirring for the reaction of precursors (typically tetraethyl orthosilicate) in a concentrated alcoholic solution (29, 32, 33), which consumes a lot of energy. For example, the formation of Fe₃O₄₋ₙSiO₂₋ₘSiO₂ nanohybrids required 6 hours of stirring while tetraethyl orthosilicate was added dropwise into an ethanol solution that contained the core nanoparticles (29). In addition, a high concentration of ammonia was often added into the alcoholic solution as catalysts (29, 32, 33). The use of high concentration of alcohol and ammonia makes the Stober method not environmentally friendly.

Accordingly, it is desired to provide new and improved methods to synthesize core-shell nanomaterials and novel core-shell nanomaterials having improved properties.

It is further desired to provide a method of synthesizing nanohybrids that does not require the reduction agent trisodium citrate, ascorbic acid, and/or hydroxylamine for the growth of shell on the core material.

It is still further desired to provide a method of synthesizing nanohybrids that does not require the use of ligands or surfactants.

It is still further desired to provide a method of synthesizing nanohybrids that does not require the use of polyvinylpyrrolidone (PVP) as a surfactant.

It is still further desired to provide a method of synthesizing nanohybrids that requires less energy input and fewer chemicals than conventional methods, and is thereby more environmentally friendly than conventional methods.

It is still further desired to provide a method of synthesizing nanohybrids that enables tuning of shell thickness and core diameter without the use of organic chemicals, such as reducing agents, ligands, and surfactants.

It is still further desired to provide a method of synthesizing nanohybrids that eliminates impurities of any individual precursor nanoparticles.

It is still further desired to provide a method of synthesizing nanohybrids that does not require any purification steps.

All references cited herein are incorporated herein by reference in their entireties.

### BRIEF SUMMARY OF THE INVENTION

A first aspect of the invention comprises a method of forming core-shell nanohybrids, said method comprising providing first nanoparticles and second nanoparticles in a liquid medium at a pH at which the first nanoparticles are neutral and the second nanoparticles are negatively or positively charged; allowing the first nanoparticles to homoaggregate; forming a core of at least one of the first nanoparticles; and allowing the second nanoparticles to heteroaggregate with the homoaggregated first nanoparticles to form a shell on the core so as to provide the core-shell nanohybrids.

In certain embodiments, the method is conducted at a temperature of 20-25° C.

In certain embodiments, the method is conducted without organic reducing agents, organic solvents, organic ligands, or organic surfactants.

In certain embodiments, the method is conducted without stirring.

In certain embodiments, the method is conducted wherein a base or an acid is added to the liquid medium to adjust the pH of the liquid medium to a pH point of zero charge of the first nanoparticles.

In certain embodiments, the liquid medium of the method is an aqueous solution.

In certain embodiments of the method, the first nanoparticles and the second nanoparticles are two different members selected from the group consisting of carbon nanotubes, cadmium telluride nanoparticles, graphene nanoparticles, magnetite nanoparticles, molybdenum disulfide nanoparticles, silver nanoparticles, palladium nanoparticles, gold nanoparticles, silicon nanoparticles, titanium oxide nanoparticles, and quantum dots.

In certain embodiments of the method, the first nanoparticles are hematite nanoparticles and the second nanoparticles are carboxylated polystyrene nanoparticles.

In certain embodiments, the method further comprises adjusting a concentration ratio of the second nanoparticles to the first nanoparticles to adjust a size of the core-shell nanohybrids.

In certain embodiments of the method, a suspension of the core-shell nanohybrids is free of unaggregated first nanoparticles and unaggregated second nanoparticles without conducting a purification step.

In certain embodiments of the method, a concentration ratio of the second nanoparticles to the first nanoparticles is minimized to form the suspension of the core-shell nanohybrids free of unaggregated first nanoparticles and unaggregated second nanoparticles.

In certain embodiments of the method, the core comprises only one of the first nanoparticles.

In certain embodiments of the method, the shell comprises nanogaps configured to allow access of substrates to the core.

A second aspect of the invention is a nanohybrid comprising a core comprising at least one neutral nanoparticle within a shell comprising charged nanoparticles, wherein the shell further comprises nanogaps configured to allow access of substrates to the core.

In certain embodiments of the nanohybrid, the shell comprises either positively charged nanoparticles or negatively charged nanoparticles.

In certain embodiments of the nanohybrid, the at least one neutral nanoparticle and the charged nanoparticles are members selected from the group consisting of carbon nanotubes, cadmium telluride nanoparticles, graphene nanoparticles, magnetite nanoparticles, molybdenum disulfide nanoparticles, silver nanoparticles, palladium nanoparticles, gold nanoparticles, silicon nanoparticles, titanium oxide nanoparticles, and quantum dots.

In certain embodiments of the nanohybrid, the at least one neutral nanoparticle comprises hematite nanoparticles and the charged nanoparticles comprise carboxylated polystyrene nanoparticles.

### BRIEF DESCRIPTION OF THE DRAWINGS

The invention will be described in conjunction with the following drawings, wherein:

FIG. 1A is a TEM image of primary HemNPs.

FIG. 1B is a graph of Zeta potential of 4.4 mg/L HemNPs at different pH.

FIG. 1C shows growth curves of hydrodynamic diameter of 8.8 mg/L HemNPs during homoaggregation at different pH over time. The inset of FIG. 1C is a TEM image of primary HemNPs.

FIG. 1D is a graph of the initial growth rate (nm/min) of hydrodynamic diameter of HemNPs at different pH, wherein error bars represent the standard deviations of at least duplicate samples. All experiments were performed at 1 mM NaCl.

FIG. 2A is a TEM image of primary 43 nm carboxylated PSNPs.

FIG. 2B is a graph of hydrodynamic diameter (Dₕ) measurement of 43 nm and 107 nm carboxylated PSNPs at pH 6.3. All experiments were performed at 1 mM NaCl.

FIG. 3A is a graph showing growth and stabilization of hydrodynamic diameter during heteroaggregation of 8.8 mg/L HemNPs with varied concentrations of 43 nm carboxylated PSNPs. Schematics of HemNP-PSNP core-shell structures are also shown.

FIG. 3B is graph showing stabilized hydrodynamic diameter and zeta potential of core-shell nanohybrids as a function of the concentration of 43 nm carboxylated PSNPs. The error bars represent the standard deviations of duplicate experiments. All the experiments were conducted at 1 mM NaCl and pH 6.3.

FIG. 4 is a graph showing growth of hydrodynamic diameter during heteroaggregation of 8.8 mg/L HemNPs with 0.84 mg/L and 0.77 mg/L 43 nm carboxylated PSNPs at 1 mM NaCl and pH 6.3.

FIGS. 5A, 5B, 5C, and 5D are TEM images of core-shell nanohybrids collected in the stable stage of heteroaggregation of 8.8 mg/L HemNPs with (A, C) 4.2 mg/L 43 nm PSNPs and (B, D) 0.91 mg/L 43 nm PSNPs. The large and dark particles are HemNPs, and the small and light particles are PSNPs.

FIGS. 6A and 6B are bar graphs showing the distribution of longest diameter of the core-shell nanohybrids formed in the stable stage of the heteroaggregation of 8.8 mg/L HemNPs with (A) 4.2 mg/L 43 nm PSNPs and (B) 0.91 mg/L 43 nm PSNPs based on TEM images.

FIGS. 6C and 6D are bar graphs showing the distribution of the number of HemNPs in the cores of the core-shell nanohybrids formed in the stable stage of the heteroaggregation of 8.8 mg/L HemNPs with (C) 4.2 mg/L 43 nm PSNPs and (D) 0.91 mg/L 43 nm PSNPs based on TEM images.

FIG. 7A is a graph showing the growth of hydrodynamic diameters during the heteroaggregation of 8.8 mg/L HemNPs with varied concentrations of 107 nm carboxylated PSNPs.

FIG. 7B is a graph showing hydrodynamic diameter and zeta potential of stabilized nanohybrids formed at different concentrations of 107 nm PSNPs. The error bar represents the standard deviation of duplicate experiments. All the experiments were conducted at 1 mM NaCl and pH 6.3.

FIGS. 8A and 8B are TEM images of core-shell nanohybrids formed in the stable stage of the heteroaggregation between 8.8 mg/L HemNPs and 4.2 mg/L 43 nm carboxylated PSNPs at 1 mM NaCl and pH 6.3. The large and dark particles are HemNPs and the small and light particles are PSNPs.

FIGS. 9A and 9B are TEM images of core-shell nanohybrids formed in the stable stage of the heteroaggregation between 8.8 mg/L HemNPs and 0.91 mg/L 43 nm carboxylated PSNPs at 1 mM NaCl and pH 6.3. The large and dark particles are HemNPs and the small and light particles are PSNPs.

FIG. 10 is a TEM image depicting the sharing of PSNPs between the core-shell nanohybrids formed during the heteroaggregation between 8.8 mg/L HemNPs and 0.91 mg/L carboxylated PSNPs.

### DETAILED DESCRIPTION OF PREFERRED EMBODIMENTS OF THE INVENTION

In this invention, a self-assembling method through heteroaggregation between neutral and charged nanoparticles is created for the formation of core-shell nanohybrids. The inventive method requires no organic solvent and extremely low energy input. In the method, NPs self-assemble into core-shell structures through Brownian motion. The size of core-shell nanohybrids can be controlled by changing the concentration ratio of neutral to charged NPs. Thus, a particularly preferred embodiment of the invention is an environmentally friendly, technically simple, and economical method for fabricating core-shell nanohybrids.

The inventive method does not require any organic chemicals such as reducing agents, ligands, or surfactants. In addition, the fabrication of core-shell nanohybrids using the inventive method is preferably done at room temperature (e.g., 20-25° C.) and requires minimum energy for mixing whereas the existing methods such as the hydrothermal method (38), the Stober method (39), the pyrolysis method (40, 41), and sol-gel method (42) require the temperature to increase to 400-600° C., 120° C., 265-280° C., and 70° C., respectively. Thus, the inventive method is much more energy efficient than existing methods.

In the inventive method, the core-shell nanohybrids are formed through spontaneous heteroaggregation between neutral nanoparticles and charged nanoparticles. When the two types of particles are mixed, homoaggregation of neutral nanoparticles and heteroaggregation between neutral nanoparticles and charged nanoparticles takes place. The heteroaggregation forms neutral NP-charged NP heteroaggregates. The size of heteroaggregates increased initially and became stable afterwards. The neutral NPs and charged NPs form core-shell structure in which neutral NPs are the cores and charged NPs are the shells.

The size of the core-shell nanohybrids can be controlled by varying the concentration ratio of charged NPs to neutral NPs. The core diameter of the core-shell nanohybrids can be controlled by this inventive method through changing the concentration ratio of the charged NPs to neutral NPs. The shell thickness can be controlled by selecting the size of charged NPs in the inventive method.

The neutral NPs and charged NPs can be made of any materials. The charged NPs in the heteroaggregation with neutral NPs to form core-shell nanohybrids can be either positively charged NPs or negatively charged NPs. The inventive method can also be utilized to synthesize core-shell nanohybrids having both positively and negatively charged NPs in the shell to serve multifunctional purposes.

A non-limiting exemplary list of materials for the neutral NPs and charged NPs includes: carbon nanotubes, cadmium telluride NPs, graphene NPs, magnetite NPs, molybdenum disulfide nanoparticles, silver NPs, palladium NPs, gold NPs, silicon NPs, titanium oxide NPs, quantum dots, etc. A preferred embodiment includes hematite NPs (HemNPs) as the neutral NPs and polystyrene NPs (PSNPs) as the charged NPs.

Any nanoparticles of interest can be made neutral by adjusting the pH of the solution to the pH point of zero charge (pH_{pzc}) of that nanoparticle. For example, pH_{pzc} of TiO₂ NPs is ˜6.8 (43), pH_{pzc} of SiO₂ NPs is ˜2.1 (44), pH_{pzc} of silver NPs is ˜7 (45), pH_{pzc} of CuO NPs is ˜9 (46), pH_{pzc} of graphene oxide NPs is ˜3 (46), pH_{pzc} of carbon nanotubes is ˜7.10 (47), pH_{pzc} of multiwalled carbon nanotubes is ˜5.43 (48), pH_{pzc} of magnetite NPs is ˜7.90 (49), pH_{pzc} of palladium NPs is ˜7.80 (50), and pH_{pzc} of ZnO NPs is ˜9.30 (51). At pH values other than the pH_{pzc} the nanoparticles of interest are either positively or negatively charged. Usually, NPs will be negatively charged at the pH higher than its pH_{pzc} and positively charged at the pH lower than its pH_{pzc}. If the pH is properly adjusted so that it is the pH_{pzc} of a first certain material NPs but much different from the pH_{zpc} of a second different material NPs, at this specific pH the first NPs are the neutral NPs and the second NPs are the charged NPs. In a preferred embodiment, the pH of a 1 mM NaCl dispersant solution was adjusted to 6.34 so that hematite nanoparticles (HemNPs) were neutral and underwent favorable homoaggregation whereas polystyrene nanoparticles (PSNPs) were negatively charged and underwent no homoaggregation.

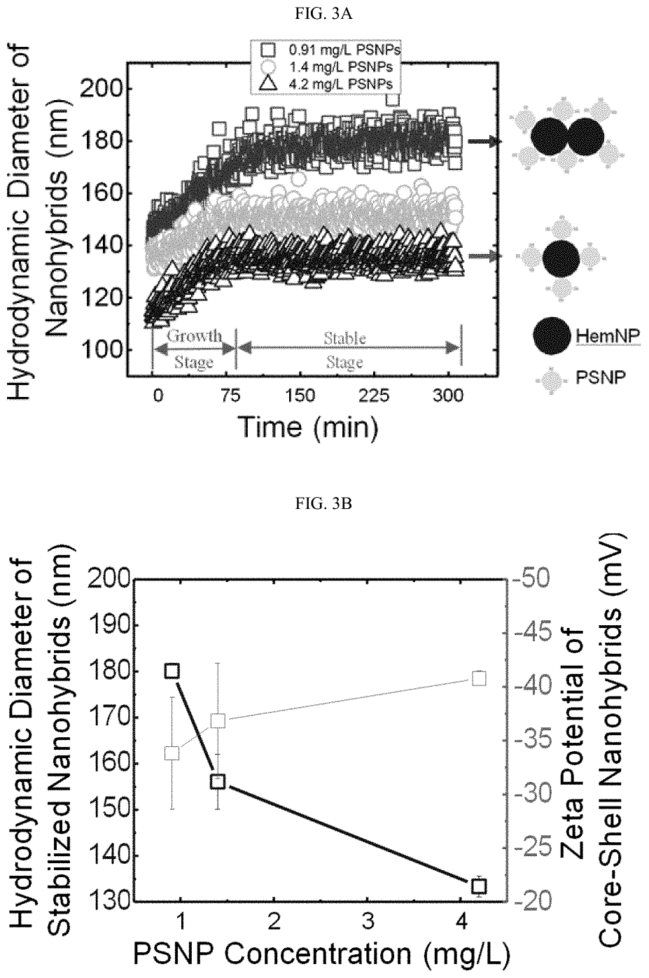

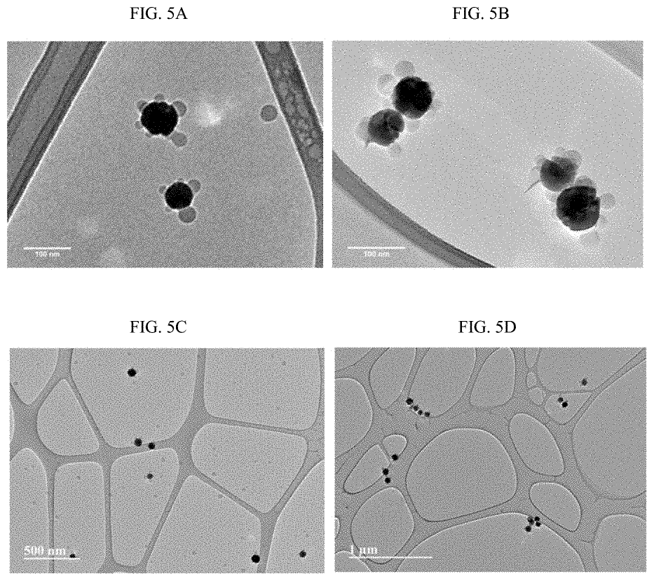

In a preferred embodiment when HemNPs and PSNPs were mixed, homoaggregation of HemNPs and heteroaggregation between HemNPs and charged PSNPs took place simultaneously, forming neutral NP-charged NP heteroaggregates. As seen in FIG. 3A, the size of heteroaggregates increased initially and became stable afterwards, as shown by the hydrodynamic diameter measurement using dynamic light scattering (DLS). The transmission electron microscopy (TEM) images of heteroaggregates in FIGS. 5A and 5B at the stable stage show that neutral HemNPs and charged PSNPs formed core-shell structure in which neutral HemNPs are the cores and charged PSNPs are the shells. As seen in FIGS. 5B and 5D, at the lowest concentration ratio of charged nanoparticles to neutral nanoparticles, the colloidally stable core-shell nanohybrids could still form though heteroaggregation (e.g., at 0.91 mg/L PSNPs). The suspension after heteroaggregation stabilization only contained core-shell nanohybrids without impurities of individual charged or neutral particles. When the ratio of charged to neutral nanoparticles is controlled at a minimum level that is still high enough for self-stabilized heteroaggregation, preferred embodiments of the method of the invention will not require additional purification steps.

As seen in FIG. 3B, the elevated concentration of charged PSNPs reduced the size of the colloidally stable nanohybrids. An elevated concentration of charged PSNPs appears to allow the charged PSNPs to quickly surround neutral HemNPs before the neutral HemNPs had the chance to attach to other neutral HemNPs. Decreasing the concentration of the charged PSNPs resulted in a larger size of stable nanohybrids because neutral HemNPs could attach to each other through direct contact or bridging by an intermediate charged NP. The differences in the concentration of charged PSNPs and the size of the stable nanohybrids is seen in comparing the TEM images of FIGS. 5A and 5B, which show the HemNP-PSNP core-shell nanohybrids at 8.8 mg/L HemNPs and 4.2 mg/L PSNPs and 0.91 mg/L PSNPs, respectively.

An advantage of nanohybrids produced using the inventive method is that there are nanogaps in the shell in the core-shell nanohybrids. The nanogaps in the shell can allow the access of the substrates to the core, which is critical for the reaction of substrates with the core material to take place in some applications and for the synergistic effect of the core and shell materials. The core-shell nanohybrids with these nanogaps could be used in the field of catalytic oxidation and reduction, photocatalysis, environmental remediation, biosensors, bioimaging, drug delivery, etc.

The invention will be illustrated in more detail with reference to the following Examples, but it should be understood that the present invention is not deemed to be limited thereto.

### EXAMPLES

Materials and Methods

Materials. HemNP stock suspension was synthesized through the forced hydrolysis of FeCl₃ (34, 35). Carboxylated PSNPs of two different sizes (i.e., 43 nm and 107 nm) were purchased from Polysciences, Inc. The deionized (DI) water (Millipore, MA) used in this study had a resistivity of 18.2 MSΩ·cm.

Estimation of NP Number Concentrations. The number concentration of NPs was estimated by dividing the mass concentration of NPs by the mass of an individual NP, which was calculated by multiplying the volume of NP by the density of material (i.e., 5300 kg/m³ for hematite and 1040 kg/m³ for polystyrene). The volume of NP was calculated assuming it is spherical, and its diameter is equal to the average hydrodynamic diameter of primary NPs measured by dynamic light scattering (DLS).

Zeta Potential Measurements. Zeta potential of NPs (i.e., HemNPs and PSNPs) and core-shell nanohybrids were measured using the dip cell (ZEN1002) in a Zetasizer Nano ZS90 (Malvern). The scattered light intensities of the highest concentrations of PSNPs, i.e., 4.2 mg/L 43 nm PSNPs and 14 mg/L 107 nm PSNPs were 1% and 36%, respectively, of that of 8.8 mg/L HemNPs. Thus, the zeta potential measurements in the stable stage of heteroaggregation between 8.8 mg/L HemNPs and various concentrations of PSNPs mainly represent the zeta potential of nanohybrids that contained HemNPs rather than individual PSNPs if there were any.

Aggregation Kinetics. Homoaggregation and heteroaggregation kinetics were studied by measuring the hydrodynamic diameter (Dₕ) in real time using a Zetasizer Nano ZS90 (Malvern), with scattering angle selected as 90°; the measurement position fixed in the center of the cell; autocorrelation time reduced to 15 s; no delay between measurements; and the attenuation increased to the highest value (11).

The 1 ml 8.8 mg/L HemNPs suspension at 1 mM NaCl were prepared and sonicated (Branson M3800, output power 120 W, frequency 40 kHz) for five minutes to achieve an aggregate-free suspension where the HemNPs had the hydrodynamic diameter of 100 nm. Homoaggregation of HemNPs was initiated by adjusting the pH to the value of interest by introducing adequate amount of NaOH or HCl stock solution and homogenizing the suspension by brief hand swirling. Immediately after that, the suspension was transferred to the cuvette very quickly before continuous measurements of hydrodynamic diameter were started. For heteroaggregation experiments, all the steps were the same except for adding the predetermined volume of carboxylated PSNP stock suspension right after adjusting the pH. All aggregation experiments were at least duplicated.

Transmission Electron Microscopy. Structures of core-shell nanohybrids were studied using a transmission electron microscope (PHILIPS CM 200) in a bright field mode at 120 kV. Gold grids (ultrathin carbon film on lacey carbon support film, 300 mesh, TED PELLA, INC.) were firstly soaked in 0.1 g/L poly-L-lysine (PLL) for 30 minutes to create a positively charged PLL coating on the surface of the grid. Then, the grid was washed with DI water. Afterwards, the PLL-coated grid was soaked in the suspension of stable heteroaggregates of interest for about 1.5 hours. The suspensions of stable heteroaggregates were prepared by performing heteroaggregation experiments of interest for 120 min. Since the stable heteroaggregates were all negatively charged, they could readily attach to the positively charged PLL-coated grids during soaking. Superposition of different heteroaggregates on the grid was unlikely to happen due to the electrostatic repulsion between heteroaggregates in the stable stage.

Then, the grid was taken out of the heteroaggregate suspension and washed gently by dipping the grid in DI water several times to remove any particles that were loosely bound to the grid. After washing, the grid was air dried. As only the strongly attached heteroaggregates remained on the surface of the grids after washing, the DI water film on the grids was not likely to bring nanoparticles together and cause artifacts during the drying process. Thus, this method of collecting heteroaggregates on TEM grids should be able to retain the original heteroaggregate structure in the aqueous solution. Following the same procedure, the TEM grids for imaging primary HemNPs and PSNPs were also prepared.

### Example 1—Hematite Nanoparticles (HemNPs) as Model Neutral NPs and Carboxylated Polystyrene Nanoparticles (PSNPs) as Model Charged NPs at pH 6.3

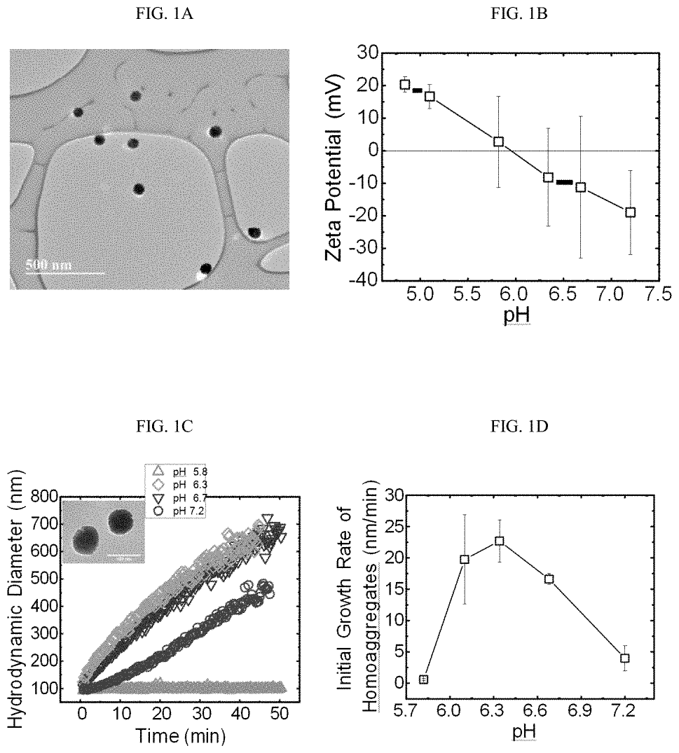

In this example, HemNPs were used as the model neutral NPs. As shown in FIG. 1A and the inset in FIG. 1C, HemNPs have spherical shape and the diameter of primary HemNPs is 75 nm on average as measured from those transmission electron microscopic (TEM) images. The point of zero charge (PZC) of HemNPs was determined by electrophoretic mobility measurement. FIG. 1B shows zeta potential of HemNPs at 1 mM NaCl as a function of pH, which progressively decreased with the increase of pH from 20 mV at pH 4.84 to −19 mV at the pH 7.2. The PZC of HemNPs is estimated to be pH 6.0 by interpolation. A decrease of pH from the PZC makes the zeta potential of HemNPs positive, and an increase of pH from the PZC makes their zeta potential negative. The standard deviation of zeta potential measurement is large when the pH is close to PZC due to the limitation of zeta potential analyzer when the electrophoretic mobility of nanoparticles is low.

To better determine the PZC of HemNPs from the perspective of colloidal stability, homoaggregation experiments of HemNPs were conducted at 1 mM NaCl and different pHs. The growth rate of HemNP homoaggregates is expected to be the highest at its PZC. The average hydrodynamic diameter (Dₕ) of HemNPs before aggregation was 100 nm as determined by DLS. In this example, the size of NPs or nanohybrids refers to the average Dₕ, unless otherwise stated. The homoaggregation experiments of HemNPs were performed from pH 5.8 to pH 7.2 in order to find the pH at which HemNPs have the most favorable homoaggregation. FIG. 1C shows the homoaggregation profile of 8.8 mg/L HemNPs in the presence of 1 mM NaCl at pH 5.8, 6.3, 6.7, and 7.2 for at least 45 minutes. At pH 5.8, Dₕ shows no increase with time as the positively charged HemNPs were colloidally stable due to the electrostatic repulsion. At pH 6.3, 6.7, and 7.2, homoaggregation of HemNPs took place and resulted in the growth of Dₕ with time. FIG. 1D shows the growth rate of HemNPs as a function of pH, calculated from the linear least-squares analysis of the growth of hydrodynamic diameters during the initial five minutes of homoaggregation. From pH 5.8, the initial growth rate of HemNPs increased with the increase of pH and reached maximum at pH 6.2±0.1 at which the surface charge of HemNPs should be very close to neutral, thus resulting in the fastest homoaggregation. A further increase of pH from this point resulted in decrease of growth rate due to that HemNPs became negatively charged as shown in FIG. 1B. Hence, in order to use HemNPs as model neutral NPs for the fabrication of core-shell nanohybrids, all heteroaggregation experiments were performed at pH 6.3±0.1.

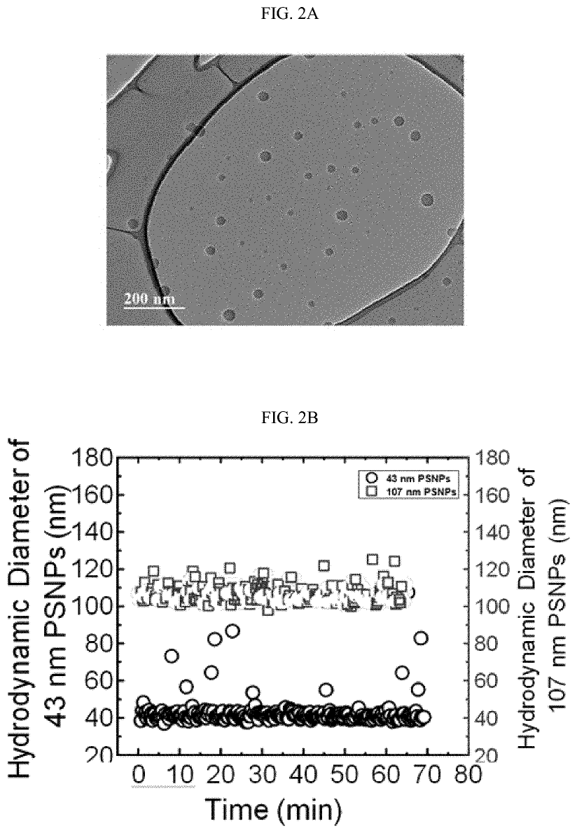

Carboxylated PSNPs of two different sizes (i.e., 43 nm and 107 nm) were used as the model charged NPs. FIG. 2A shows the TEM image of 43 nm PSNPs which confirm the spherical shape of PSNPs. At pH 6.3, zeta potentials of 43 nm and 107 nm PSNPs were −39.6±3.9 mV (avg. ±SD.) and −43.5±0.4 mV (avg. ±SD.), respectively, in the presence of 1 mM NaCl. At the same solution chemistry, Dₕ of both PSNPs maintained stable as shown in FIG. 2B due to electrostatic repulsion. The concentrations of 43 nm and 107 nm PSNPs used in this study were 0.91-4.2 mg/L and 5.6-14 mg/L, respectively, giving scattered light intensity of 4-16 kcps and 270-640 kcps, respectively, in DLS measurement, which are considerably lower than that of 8.8 mg/L HemNPs (1500 kcps). Thus, when PSNPs were mixed with 8.8 mg/L HemNPs at pH 6.3, the hydrodynamic diameter of mixed NPs measured by DLS mainly represents that of HemNPs and nanohybrids containing HemNPs without much interference by free PSNPs. Especially in the case of 43 nm PSNPs, free PSNPs can be considered “invisible” to the detector of DLS instrument. This method was also used in previous heteroaggregation studies (34, 36).

### Example 2—Formation of Core-Shell Nanohybrids Through Self-Assembling of Neutral and Charged Nanoparticles in Heteroaggregation Process

Heteroaggregation experiments between model neutral NPs (e.g., HemNPs) and model charged NPs (e.g., carboxylated PSNPs) were conducted at 1 mM NaCl and pH 6.3. At this solution chemistry, HemNPs were neutral and could undergo not only favorable homoaggregation (FIG. 1C) but also heteroaggregation with PSNPs due to van der Waals forces whereas PSNPs were negatively charged and thus colloidally stable to homoaggregation due to electrostatic repulsion. The suspension containing the two types of NPs was homogenized by briefly swirling with hands and then left stationary to allow the heteroaggregation of NPs to take place through Brownian motions. FIG. 3A shows heteroaggregation profiles of 8.8 mg/L HemNPs with three different concentrations (i.e., 0.91, 1.4, and 4.2 mg/L) of 43 nm carboxylated PSNPs. At 4.2 mg/L PSNPs, the number ratio of HemNPs to PSNPs was estimated to be 1:30. Dₕ increased initially (growth stage) due to the attachment of PSNPs to the surface of HemNPs. Then, it became stable at 133 nm on average (FIGS. 3A and 3B) after ˜80 min (stable stage) because sufficient amount of PSNPs had attached to each primary HemNP and formed core-shell structure with HemNPs as the cores and PSNPs as the shells as illustrated by the schematic in FIG. 3A. At a lower concentration of PSNPs, 1.4 mg/L, the number ratio of HemNPs to PSNPs was estimated to be 1:10. Since the number of PSNPs surrounding each HemNP has significantly dropped, there was a higher chance for a HemNP to attach to other HemNPs before the shell of PSNPs formed around the HemNP. Thus, homoaggregation of HemNPs and heteroaggregation between HemNPs and PSNPs may have taken place simultaneously, resulting in the initial increase in Dₕ from 133 nm to 156 nm (FIG. 3A). Dₕ stabilized after ˜100 min at 156 nm on average (FIGS. 3A and 3B) due to the formation of core-shell structure of HemNP-PSNP nanohybrids. The larger stabilized Dₕ (FIG. 3B) is likely due to the formation of larger cores of HemNPs. A further decrease of the concentration of PSNPs to 0.91 mg/L (number ratio of HemNPs to PSNPs is 1:7) allowed more HemNPs to undergo homoaggregation before HemNP cores were shielded by PSNP shells, which resulted in further increase of the stabilized Dₕ to 180 nm on average (FIGS. 3A and 3B). The zeta potential of stabilized nanohybrids became less negative from −40.8 to −33.8 mV as the concentration of the PSNPs decreased from 4.2 mg/L to 0.91 mg/L (FIG. 3B), probably due to that the shell of PSNPs became less compact when there were fewer PSNPs available in the suspension.

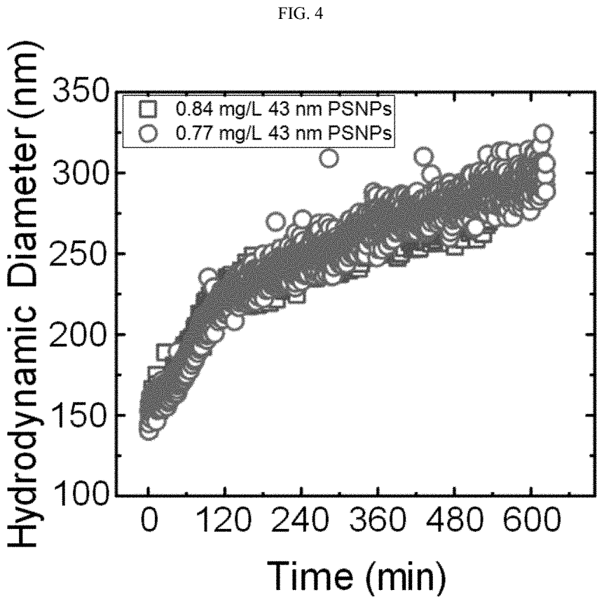

A further decrease of the concentration of PSNPs from 0.91 mg/L to 0.84 mg/L (HemNPs: PSNPs=1:6.1), and to 0.77 mg/L (HemNPs: PSNPs=1:5.6) in heteroaggregation resulted in a continuous increase of Dₕ which never stabilized within the time frame of experiments (FIG. 4). As the concentration of PSNPs was too low, the number of PSNPs was not enough to form shells around and stabilize HemNPs. The continuous increase of Dₕ of heteroaggregates was due to both homoaggregation of HemNPs and the heteroaggregation. The similar hypothesis on the formation of core-shell structure between neutral CeO₂ NPs and negatively charged biochar NPs was proposed by Yi et al. (36) to explain the self-stabilization phenomena during their heteroaggregation.

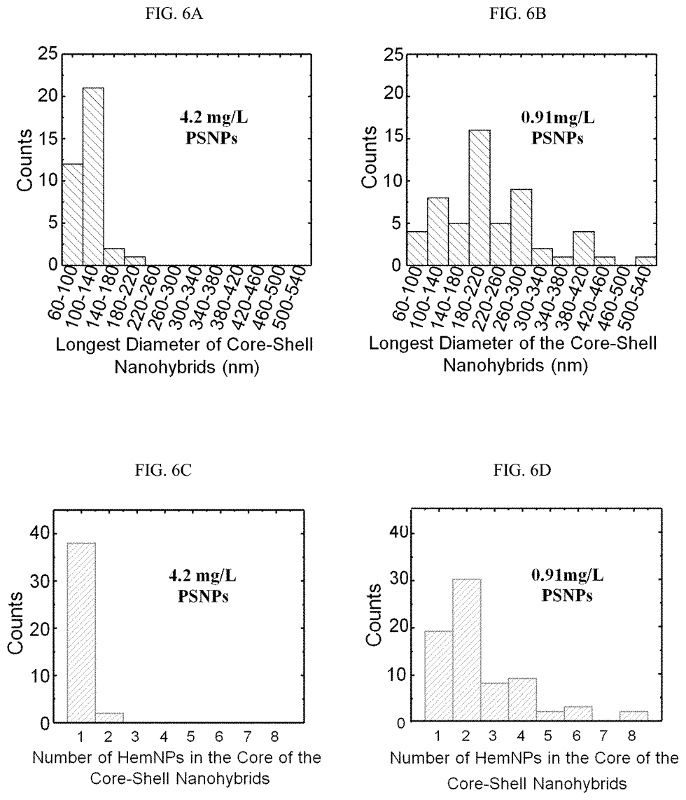

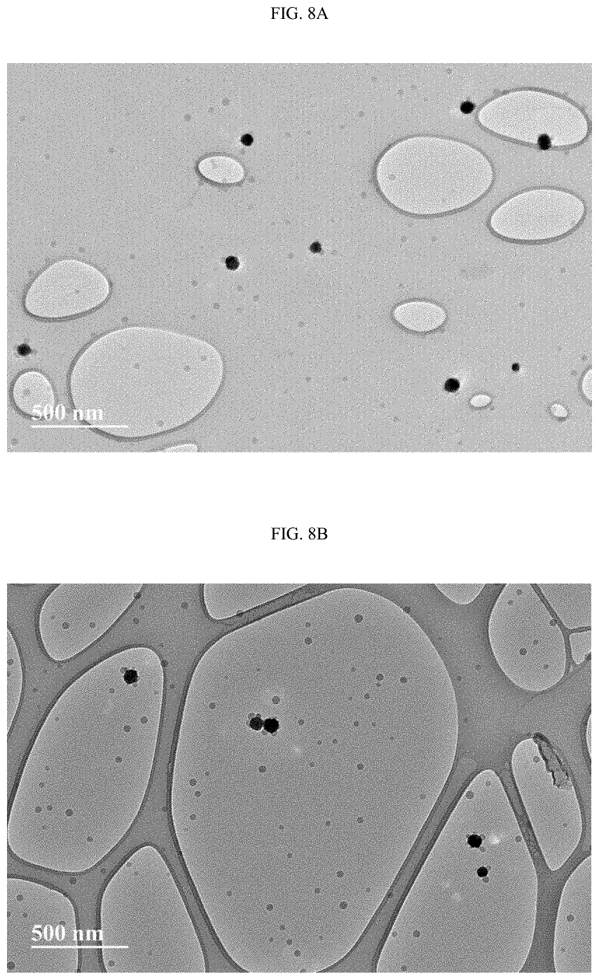

In order to prove the hypothesis of formation of core-shell nanohybrids in the heteroaggregation process, the transmission electron microscopy (TEM) images of heteroaggregates (FIGS. 5A and 5B) collected in the stable stage were taken using the sample preparation method that can avoid the superposition of particles on the TEM grids during the drying process and thus retain the aggregate structure. As shown in FIG. 5A, the HemNP-PSNP core-shell structure indeed had formed in the stable stage of the heteroaggregation between 8.8 mg/L HemNPs and 4.2 mg/L 43 nm carboxylated PSNPs. FIGS. 5C, 8A and 8B provide broader views of particles existing in the suspension, in which a lot of free individual PSNPs can be seen in addition to core-shell nanohybrids. Particularly, FIGS. 8A and 8B show TEM images of core-shell nanohybrids formed in the stable stage of the heteroaggregation between 8.8 mg/L and 43 nm carboxylated PSNPs at 1 mM NaCl and pH 6.3. The large and dark particles visible in FIGS. 8A and 8B are HemNPs and the small and light particles are PSNPs. Due to the presence of abundant PSNPs, almost all the core-shell nanohybrids had only one HemNP as the core (FIG. 6C) which is surrounded by 3-7 PSNPs as the shell. The average longest diameter of nanohybrids is 110 nm based on the size distribution of all core-shell nanohybrids (FIG. 6A) found from eight TEM images.

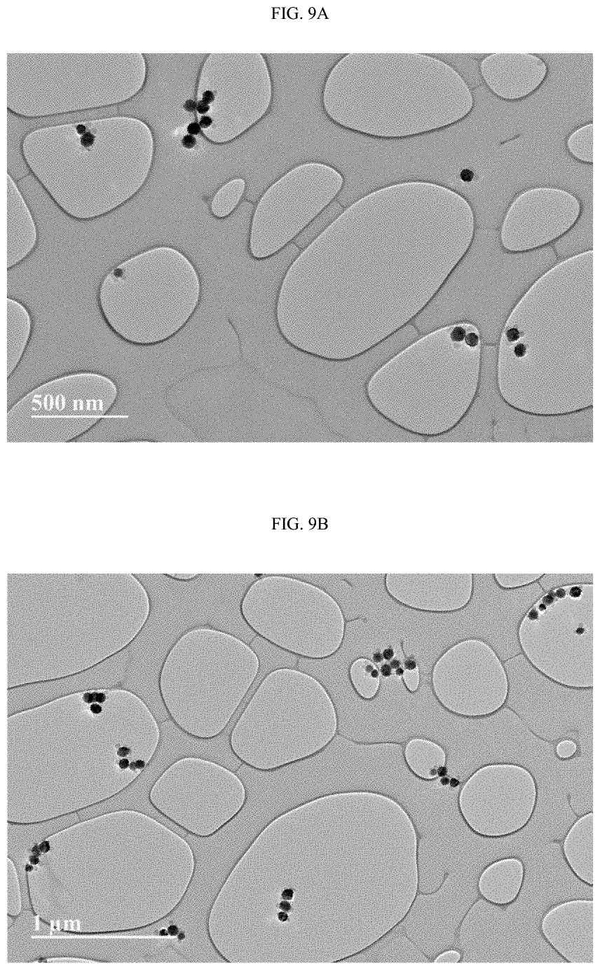

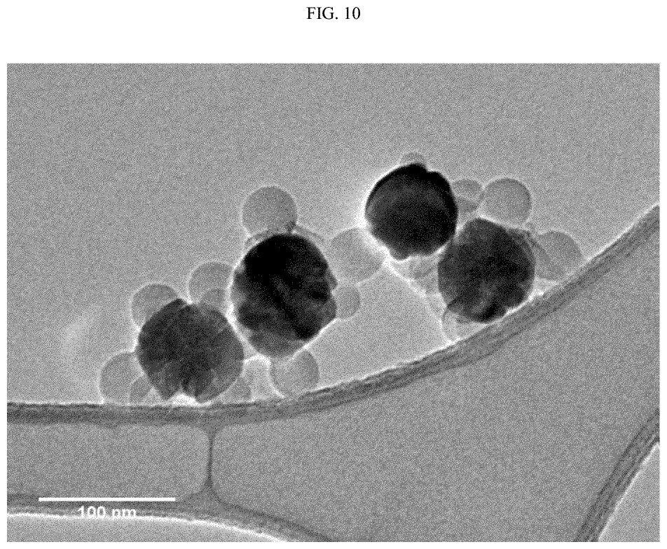

FIGS. 5B, 5D, 9A, and 9B show the TEM images of heteroaggregate structure formed in the stable stage of heteroaggregation between 8.8 mg/L HemNPs and 0.91 mg/L 43 nm carboxylated PSNPs at 1 mM NaCl and pH 6.3. The large, dark particles visible in the TEM images are HemNPs and the smaller, lighter particles are PSNPs. The observation is also consistent with the hypothesis. Larger core-shell nanohybrids had formed with multiple (i.e., 1-8) HemNPs as the core (FIG. 6D) and PSNPs as the shell. In a few cases, the HemNPs in the core were connected through a bridging PSNP (FIG. 10) rather than direct contact. FIG. 10 shows a TEM image illustrating the sharing of PSNPs between the core-shell nanohybrids formed during the heteroaggregation between 8.8 mg/L HemNPs and 0.91 mg/L carboxylated PSNPs. In FIG. 10, the larger darker particles shown are HemNPs and the smaller lighter particles are PSNPs. There were almost no free individual PSNPs in the suspension (FIGS. 5B, 5D, 9A, and 9B). All PSNPs had bound to HemNPs, preventing HemNPs from growing through homoaggregation. The number ratio of HemNPs to PSNPs within the nanohybrids was 1:2-1:7, which is interestingly very similar to the ones formed at 4.2 mg/L PSNPs. The statistical analysis on the size of nanohybrids in seventeen TEM images revealed that the average longest diameter is 213 nm (FIG. 6B), which is much larger than the ones formed at 4.2 mg/L PSNPs, consistent with the findings in the measurement of their hydrodynamic diameters (FIG. 3).

### Example 3—Effect of Size of Charged Nanoparticles on the Formation of Nanohybrids

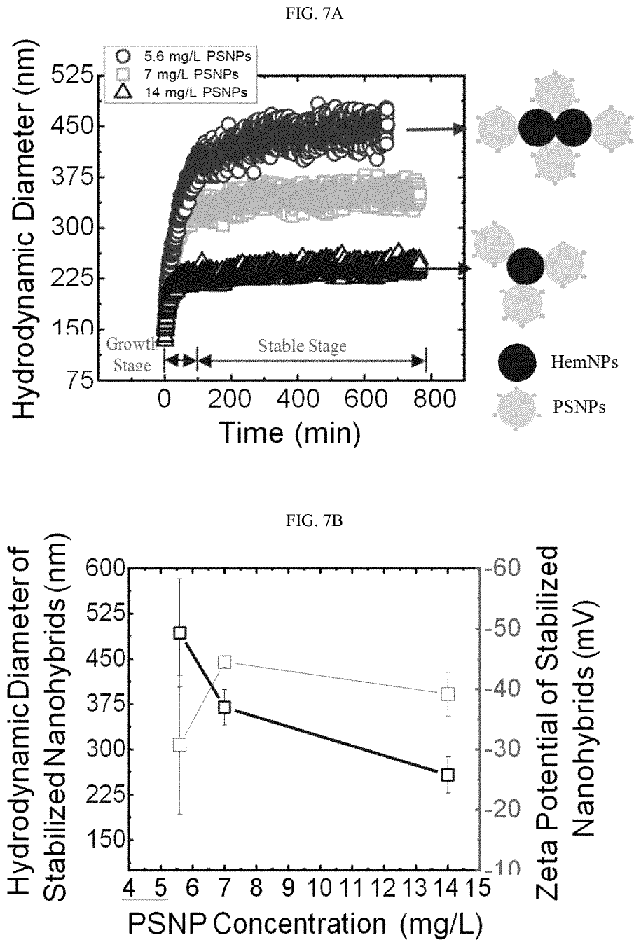

The size of model charged nanoparticles (i.e., carboxylated PSNPs) was increased from 43 nm to 107 nm to study the influence of such size increase on the formation of nanohybrids with the same model neutral nanoparticles (i.e., 100 nm HemNPs) under the same solution chemistry (i.e., pH 6.3 and 1 mM NaCl). FIG. 7A shows the growth of hydrodynamic diameter during the heteroaggregation of 8.8 mg/L HemNPs with 107 nm carboxylated PSNPs at three different concentrations (i.e., 5.6, 7, 14 mg/L) where the number ratios of HemNPs to PSNPs are 1:2.6, 1:3.3, and 1:6.6, respectively. Similar to the heteroaggregation with 43 nm PSNPs, the heteroaggregation of HemNPs with 107 nm PSNPs sequentially had a growth stage and a stable stage. Thus, it is a reasonable speculation that HemNPs and 107 nm PSNPs had also formed core-shell nanohybrids with HemNPs as the core and PSNPs as the shell in the stable stage, as illustrated by the schematics in FIG. 7A. As the PSNP concentration decreased, the core of HemNPs had more opportunities to grow through homoaggregation before being surrounded and stabilized by PSNPs, thus resulting in the larger size of nanohybrids in the stable stage (FIG. 7B). The zeta potential of nanohybrids was less negative at 5.6 mg/L PSNPs compared to that at 7 or 14 mg/L (FIG. 7B), probably because there were fewer PSNPs attaching to each HemNP in the nanohybrids at 5.6 mg/L. It is also interesting to note that the number ratios of PSNPs to HemNPs required to form stabilized nanohybrids are much lower for 107 nm PSNPs (2.6-6.6) compared with that for 43 nm PSNPs (7-30), likely due to a larger PSNP shielding more surface area of the HemNP than a smaller PSNP. In addition, the size of the stabilized nanohybrids formed using 107 nm PSNPs is 220-440 nm which is larger than the nanohybrids (133-180 nm) formed using 43 nm PSNPs, probably ascribed to the thicker PSNP shells. The TEM images of nanohybrids of HemNPs and 107 nm PSNPs are not provided because the two NPs had similar darkness, shape, and size under the microscope, making it difficult to differentiate them.

### CONCLUSION

Core-shell nanohybrids can be formed through spontaneous heteroaggregation between model neutral NPs (e.g., HemNPs) and model charged NPs (e.g., carboxylated PSNPs) under room temperature and stationary condition. It is expected that other types of neutral and charged nanospheres can also self-assemble into core-shell structures using the heteroaggregation method. In the heteroaggregation process, neutral particles formed the cores and charged particles formed the shells. The size of nanohybrids became larger when the number ratio of neutral to charged nanoparticles increased. When there were fewer charged particles around, neutral particles were more likely to grow to a larger core through homoaggregation before being surrounded and shielded by the charged particles. The number ratio of neutral to charged nanoparticles required for making stable nanohybrids, and the size of nanohybrids increased as the charged NPs became larger. The formation of core-shell nanohybrids through heteroaggregation requires no heating and almost no external mixing, which renders the process more energy efficient than existing methods of making core-shell nanohybrids.

While the invention has been described in detail and with reference to specific examples thereof, it will be apparent to one skilled in the art that various changes and modifications can be made therein without departing from the spirit and scope thereof.

### REFERENCES CITED

1. Huang, X. Q.; Li, Y. J.; Chen, Y.; Zhou, H. L.; Duan, X. F.; Huang, Y., Plasmonic and Catalytic AuPd Nanowheels for the Efficient Conversion of Light into Chemical Energy. Angew Chem Int Edit 2013, 52, (23), 6063-6067.
2. Zhang, Y.; Dai, T.; Zhang, F.; Zhang, J.; Chu, G.; Quan, C., Fe3O4@UiO-66-NH2 core-shell nanohybrid as stable heterogeneous catalyst for Knoevenagel condensation. Chinese Journal of Catalysis 2016, 37, (12), 2106-2113.
3. Ipe, B. I.; Niemeyer, C. M., Nanohybrids composed of quantum dots and cytochrome P450 as photocatalysts. Angew Chem Int Ed Engl 2006, 45, (3), 504-7.
4. Li, J.; Cushing, S. K.; Bright, J.; Meng, F.; Senty, T. R.; Zheng, P.; Bristow, A. D.; Wu, N., Ag@Cu2O Core-Shell Nanoparticles as Visible-Light Plasmonic Photocatalysts. ACS Catalysis 2012, 3, (1), 47-51.
5. He, L.; Liu, Y.; Liu, J.; Xiong, Y.; Zheng, J.; Liu, Y.; Tang, Z., Core-shell noble-metal@metal-organic-framework nanoparticles with highly selective sensing property. Angew Chem Int Ed Engl 2013, 52, (13), 3741-5.
6. Sun, J.; Gan, T.; Li, Y.; Shi, Z.; Liu, Y., Rapid and sensitive strategy for Rhodamine B detection using a novel electrochemical platform based on core-shell structured Cu@carbon sphere nanohybrid. Journal of Electroanalytical Chemistry 2014, 724, 87-94.
7. Li, Y.; Hu, Y.; Jiang, H.; Hou, X.; Li, C., Construction of core-shell Fe₂O₃@SnO2 nanohybrids for gas sensors by a simple flame-assisted spray process. RSC Advances 2013, 3, (44).
8. Wei, Q.; Ji, J.; Shen, J., Synthesis of Near-Infrared Responsive Gold Nanorod/PNIPAAm Core/Shell Nanohybrids via Surface Initiated ATRP for Smart Drug Delivery. Macromolecular Rapid Communications 2008, 29, (8), 645-650.
9. Zhang, H.; Pan, D. K.; Zou, K.; He, J.; Duan, X., A novel core-shell structured magnetic organic-inorganic nanohybrid involving drug-intercalated layered double hydroxides coated on a magnesium ferrite core for magnetically controlled drug release. Journal of Materials Chemistry 2009, 19, (19), 3069-3077.
10. Ma, D.; Meng, L.; Chen, Y.; Hu, M.; Chen, Y.; Huang, C.; Shang, J.; Wang, R.; Guo, Y.; Yang, J., NaGdF4:Yb(3+)/Er(3+)@NaGdF4:Nd(3+)@Sodium-Gluconate: Multifunctional and Biocompatible Ultrasmall Core-Shell Nanohybrids for UCL/MR/CT Multimodal Imaging. ACS Appl Mater Interfaces 2015, 7, (30), 16257-65.
11. Covaliu, C. I.; Jitaru, I.; Paraschiv, G.; Vasile, E.; Biri [symbol] , S.- [symbol] .; Diamandescu, L.; Ionita, V.; Iovu, H., Core-shell hybrid nanomaterials based on CoFe2O4 particles coated with PVP or PEG biopolymers for applications in biomedicine. Powder Technology 2013, 237, 415-426.
12. Yang, S.; Li, Z.; Wang, Y.; Fan, X.; Miao, Z.; Hu, Y.; Li, Z.; Sun, Y.; Besenbacher, F.; Yu, M., Multifunctional Bi@PPy-PEG Core-Shell Nanohybrids for Dual-Modal Imaging and Photothermal Therapy. ACS Appl Mater Interfaces 2018, 10, (2), 1605-1615.
13. Chen, M.; Tang, S.; Guo, Z.; Wang, X.; Mo, S.; Huang, X.; Liu, G.; Zheng, N., Core-shell Pd@Au nanoplates as theranostic agents for in-vivo photoacoustic imaging, CT imaging, and photothermal therapy. Adv Mater 2014, 26, (48), 8210-6.
14. Guo, Q.; Xue, Q.; Sun, J.; Dong, M.; Xia, F.; Zhang, Z., Gigantic enhancement in the dielectric properties of polymer-based composites using core/shell MWCNT/amorphous carbon nanohybrids. Nanoscale 2015, 7, (8), 3660-7.
15. Liu, J.; Jiang, J.; Cheng, C.; Li, H.; Zhang, J.; Gong, H.; Fan, H. J., Co3O4 Nanowire@MnO2 ultrathin nanosheet core/shell arrays: a new class of high-performance pseudocapacitive materials. Adv Mater 2011, 23, (18), 2076-81.
16. Ke, Q.; Guan, C.; Zheng, M.; Hu, Y.; Ho, K.-h.; Wang, J., 3D hierarchical SnO2@Ni(OH)2 core-shell nanowire arrays on carbon cloth for energy storage application. Journal of Materials Chemistry A 2015, 3, (18), 9538-9542.
17. Balamurugan, J.; Thanh, T. D.; Kim, N. H.; Lee, J. H., Nitrogen-Doped Graphene Nanosheets with FeN Core-Shell Nanoparticles as High-Performance Counter Electrode Materials for Dye-Sensitized Solar Cells. Advanced Materials Interfaces 2016, 3, (1).
18. Etgar, L.; Yanover, D.; C apek, R. K.; Vaxenburg, R.; Xue, Z.; Liu, B.; Nazeeruddin, M. K.; Lifshitz, E.; Gratzel, M., Core/Shell PbSe/PbS QDs TiO2 Heterojunction Solar Cell. Advanced Functional Materials 2013, 23, (21), 2736-2741.
19. Yoon, I.-K.; Hwang, J.-Y.; Seo, J.-w.; Jang, W.-C.; Kim, H.-W.; Shin, U. S., Carbon nanotube-gelatin-hydroxyapatite nanohybrids with multilayer core-shell structure for mimicking natural bone. Carbon 2014, 77, 379-389.
20. Yoon, I.-K.; Hwang, J.-Y.; Jang, W.-C.; Kim, H.-W.; Shin, U. S., Natural bone-like biomimetic surface modification of titanium. Applied Surface Science 2014, 301, 401-409.
21. Larios-Rodriguez, E. A.; Castillón-Barraza, F. F.; Herrera-Urbina, R.; Santiago, U.; Posada-Amarillas, A., Synthesis of AucorePdshell Nanoparticles by a Green Chemistry Method and Characterization by HAADF-STEM Imaging. Journal of Cluster Science 2017, 28, (4), 2075-2086.
22. Gawande, M. B.; Goswami, A.; Asefa, T.; Guo, H.; Biradar, A. V.; Peng, D. L.; Zboril, R.; Varma, R. S., Core-shell nanoparticles: synthesis and applications in catalysis and electrocatalysis. Chem Soc Rev 2015, 44, (21), 7540-90.
23. Li, C.; Balamurugan, J.; Thanh, T. D.; Kim, N. H.; Lee, J. H., 3D hierarchical CoO@MnO2 core-shell nanohybrid for high-energy solid state asymmetric supercapacitors. Journal of Materials Chemistry A 2017, 5, (1), 397-408.
24. Liu, Z.; Zhao, Z.; Teng, F.; Chang, C.; Zhao, Y.; Yang, Y.; Yao, W.; Zhu, Y.; Fan, Y., In situ hydrothermal fabrication of a MnO2@CoMoO4@Ni nanohybrid electrode and ultrahigh energy density of ASCs. RSC Advances 2016, 6, (52), 46508-46515.
25. Zhu, S.; Zhang, D.; Chen, Z.; Zhang, Y., Controlled synthesis of core/shell magnetic iron oxide/carbon systems via a self-template method. Journal of Materials Chemistry 2009, 19, (41).
26. Chung, F.-C.; Wu, R.-J.; Cheng, F.-C., Fabrication of a Au@SnO2 core-shell structure for gaseous formaldehyde sensing at room temperature. Sensors and Actuators B: Chemical 2014, 190, 1-7.
27. Guo, X.; Canet, J.-L.; Boyer, D.; Gautier, A.; Mahiou, R., Sol-gel emulsion synthesis of biphotonic core-shell nanoparticles based on lanthanide doped organic-inorganic hybrid materials. Journal of Materials Chemistry 2012, 22, (13).
28. Chen, Z.; Xu, Y. J., Ultrathin TiO2 layer coated-CdS spheres core-shell nanocomposite with enhanced visible-light photoactivity. ACS Appl Mater Interfaces 2013, 5, (24), 13353-63.
29. Gai, S.; Yang, P.; Li, C.; Wang, W.; Dai, Y.; Niu, N.; Lin, J., Synthesis of Magnetic, Up-Conversion Luminescent, and Mesoporous Core-Shell-Structured Nanocomposites as Drug Carriers. Advanced Functional Materials 2010, 20, (7), 1166-1172.
30. Sotiriou, G. A.; Franco, D.; Poulikakos, D.; Ferrari, A., Optically stable biocompatible flame-made SiO2-coated Y₂O₃:Tb3+ nanophosphors for cell imaging. ACS Nano 2012, 6, (5), 3888-97.
31. Hu, Y.; Shi, Y.; Jiang, H.; Huang, G.; Li, C., Scalable preparation of ultrathin silica-coated Ag nanoparticles for SERS application. ACS Appl Mater Interfaces 2013, 5, (21), 10643-9.
32. Manivannan, K.; Cheng, C. C.; Anbazhagan, R.; Tsai, H. C.; Chen, J. K., Fabrication of silver seeds and nanoparticle on core-shell Ag@SiO₂ nanohybrids for combined photothermal therapy and bioimaging. J Colloid Interface Sci 2019, 537, 604-614.
33. Ye, M.; Zhang, Q.; Hu, Y.; Ge, J.; Lu, Z.; He, L.; Chen, Z.; Yin, Y., Magnetically recoverable core-shell nanocomposites with enhanced photocatalytic activity. Chemistry 2010, 16, (21), 6243-50.
34. Huynh, K. A.; McCaffery, J. M.; Chen, K. L., Heteroaggregation of Multiwalled Carbon Nanotubes and Hematite Nanoparticles: Rates and Mechanisms. Environ Sci Technol 2012, 46, (11), 5912-5920.
35. Chen, K. L.; Mylon, S. E.; Elimelech, M., Aggregation kinetics of alginate-coated hematite nanoparticles in monovalent and divalent electrolytes. Environ Sci Technol 2006, 40, (5), 1516-1523.
36. Yi, P.; Pignatello, J. J.; Uchimiya, M.; White, J. C., Heteroaggregation of Cerium Oxide Nanoparticles and Nanoparticles of Pyrolyzed Biomass. Environ Sci Technol 2015, 49, (22), 13294-13303.
37. Hussain, Kazi Albab, and Peng Yi. Heteroaggregation of Neutral and Charged Nanoparticles: A Potential Method of Making Core-Shell Nanohybrids through Self-Assembly. J. Physical Chemistry C 2020, 124(35), 19282-19288.
38. Qi, X.; Hu, Q.; Xu, J.; Xie, R.; Bai, Z.; Jiang, Y.; Qin, S.; Zhong, W.; Du, Y., Enhanced microwave absorption properties and mechanism of core/shell structured magnetic nanoparticles/carbon-based nanohybrids. Materials Science and Engineering: B 2016, 211, 53-60.
39. Manivannan, K.; Cheng, C. C.; Anbazhagan, R.; Tsai, H. C.; Chen, J. K., Fabrication of silver seeds and nanoparticle on core-shell Ag@SiO₂ nanohybrids for combined photothermal therapy and bioimaging. J Colloid Interface Sci 2019, 537, 604-614.
40. Li, Y.; Hu, Y.; Jiang, H.; Hou, X.; Li, C., Construction of core-shell Fe₂O₃@SnO2 nanohybrids for gas sensors by a simple flame-assisted spray process. RSC Advances 2013, 3, (44).
41. Zhang, M.; Cui, Z.; Song, R.; Lv, B.; Tang, Z.; Meng, X.; Chen, X.; Zheng, X.; Zhang, J.; Yao, Z.; Bu, W., SnWO4-based nanohybrids with full energy transfer for largely enhanced photodynamic therapy and radiotherapy. Biomaterials 2018, 155, 135-144.
42. Smitha, S.; Shajesh, P.; Mukundan, P.; Nair, T. D.; Warrier, K. G., Synthesis of biocompatible hydrophobic silica-gelatin nano-hybrid by sol-gel process. Colloids Surf B Biointerfaces 2007, 55, (1), 38-43.
43. French, R. J. A. K., B.; Isley Sara, L. Lee Penn, R.; Baveye C, P.; Influence of Ionic Strength, pH, and Cation Valence on Aggregation Kinetics of Titanium Dioxide Nanoparticles. Environ. Sci. Technol. 43, 1354-1359.
44. Penkova, A.; Martinez Blanes, J. M.; Cruz, S. A.; Centeno, M. A.; Hadjiivanov, K.; Odriozola, J. A., Gold nanoparticles on silica monospheres modified by amino groups. Microporous and Mesoporous Materials 2009, 117, (3), 530-534.
45. Getahun Merga, ‡: Robert Wilson, †,‡: Geoffrey Lynn, †, § Bratoljub H. Milosavljevic, † and; Dan Meisel*, <Silver Redox Catalysis on “Naked” Silver Nanoparticles.pdf.
46. Pendashteh, A.; Mousavi, M. F.; Rahmanifar, M. S., Fabrication of anchored copper oxide nanoparticles on graphene oxide nanosheets via an electrostatic coprecipitation and its application as supercapacitor. Electrochimica Acta 2013, 88, 347-357.
47. Carabineiro, S. A. C.; Thavorn-amornsri, T.; Pereira, M. F. R.; Serp, P.; Figueiredo, J. L., Comparison between activated carbon, carbon xerogel and carbon nanotubes for the adsorption of the antibiotic ciprofloxacin. Catalysis Today 2012, 186, (1), 29-34.
48. Pashai Gatabi, M.; Milani Moghaddam, H.; Ghorbani, M., Point of zero charge of maghemite decorated multiwalled carbon nanotubes fabricated by chemical precipitation method. Journal of Molecular Liquids 2016, 216, 117-125.
49. Illes, E.; Tombacz, E., The effect of humic acid adsorption on pH-dependent surface charging and aggregation of magnetite nanoparticles. J Colloid Interface Sci 2006, 295, (1), 115-23.
50. Hennebel, T.; De Corte, S.; Vanhaecke, L.; Vanherck, K.; Forrez, I.; De Gusseme, B.; Verhagen, P.; Verbeken, K.; Van der Bruggen, B.; Vankelecom, I.; Boon, N.; Verstraete, W., Removal of diatrizoate with catalytically active membranes incorporating microbially produced palladium nanoparticles. Water Res 2010, 44, (5), 1498-506.
51. Mohd Omar, F.; Abdul Aziz, H.; Stoll, S., Aggregation and disaggregation of ZnO nanoparticles: influence of pH and adsorption of Suwannee River humic acid. Sci Total Environ 2014, 468-469, 195-201.

What is claimed is:

1. A method of forming core-shell nanohybrids, said method comprising:
providing first nanoparticles and second nanoparticles in a liquid medium at a pH at which the first nanoparticles are neutral and the second nanoparticles are negatively or positively charged;
allowing the first nanoparticles to homoaggregate;
forming a core of at least one of the first nanoparticles; and
allowing the second nanoparticles to heteroaggregate with the homoaggregated first nanoparticles to form a shell on the core so as to provide the core-shell nanohybrids.

2. The method of claim 1, which is conducted at a temperature of 20-25° C.

3. The method of claim 1, which is conducted without organic reducing agents, organic solvents, organic ligands, or organic surfactants.

4. The method of claim 3, which is conducted without stirring.

5. The method of claim 1, wherein a base or an acid is added to the liquid medium to adjust the pH of the liquid medium to a pH point of zero charge of the first nanoparticles.

6. The method of claim 5, wherein the liquid medium is an aqueous solution.

7. The method of claim 1, wherein the first nanoparticles and the second nanoparticles are two different members selected from the group consisting of carbon nanotubes, cadmium telluride nanoparticles, graphene nanoparticles, magnetite nanoparticles, molybdenum disulfide nanoparticles, silver nanoparticles, palladium nanoparticles, gold nanoparticles, silicon nanoparticles, titanium oxide nanoparticles, and quantum dots.

8. The method of claim 1, wherein the first nanoparticles are hematite nanoparticles and the second nanoparticles are carboxylated polystyrene nanoparticles.

9. The method of claim 1, further comprising adjusting a concentration ratio of the second nanoparticles to the first nanoparticles to adjust a size of the core-shell nanohybrids.

10. The method of claim 1, wherein a suspension of the core-shell nanohybrids is free of unaggregated first nanoparticles and unaggregated second nanoparticles without conducting a purification step.

11. The method of claim 10, wherein a concentration ratio of the second nanoparticles to the first nanoparticles is minimized to form the suspension of the core-shell nanohybrids free of unaggregated first nanoparticles and unaggregated second nanoparticles.

12. The method of claim 1, wherein the core comprises only one of the first nanoparticles.

13. The method of claim 1, wherein the shell comprises nanogaps configured to allow access of substrates to the core.

14. A nanohybrid comprising a core comprising at least one neutral nanoparticle within a shell comprising charged nanoparticles, wherein the shell further comprises nanogaps configured to allow access of substrates to the core.

15. The nanohybrid of claim 14, wherein the shell comprises either positively charged nanoparticles or negatively charged nanoparticles.

16. The nanohybrid of claim 14, wherein the at least one neutral nanoparticle and the charged nanoparticles are members selected from the group consisting of carbon nanotubes, cadmium telluride nanoparticles, graphene nanoparticles, magnetite nanoparticles, molybdenum disulfide nanoparticles, silver nanoparticles, palladium nanoparticles, gold nanoparticles, silicon nanoparticles, titanium oxide nanoparticles, and quantum dots.

17. The nanohybrid of claim 14, wherein the at least one neutral nanoparticle comprises hematite nanoparticles and the charged nanoparticles comprise carboxylated polystyrene nanoparticles.
